(19) United States
(12) Patent Application Publication
(10) Pub. No.: US 2009/0109951 A1
(43) Pub. Date: Apr. 30, 2009

(54) Method and Apparatus for Counting Transmission Times of a PDU

(76) Inventor: Li-Chih Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/259,303

(22) Filed: Oct. 28, 2008

Related U.S. Application Data
(60) Provisional application No. 60/983,217, filed on Oct. 28, 2007.

(51) Int. Cl. H04J 3/00

(52) U.S. Cl. 370/345

(57) ABSTRACT

A method and apparatus for counting transmission times of a protocol data unit (PDU) in a wireless communications system is disclosed, so as to trigger a specific operation of the PDU. The method includes performing a first transmission of the PDU and configuring a counter corresponding to transmission times of the PDU; and counting one times to the counter if a transmission includes any part of the PDU after the first transmission of the PDU is performed.

### CROSS REFERENCE TO RELATED APPLICATIONS

This application claims the benefit of U.S. Provisional Application No. 60/983,217, filed on Oct. 28, 2007 and entitled “Method and Apparatus for SDU Discard and Fast Recovery in ARQ layer”, the contents of which are incorporated herein by reference.

### BACKGROUND OF THE INVENTION

1. Field of the Invention

The present invention relates to a method and apparatus for counting transmission times of a Protocol Data Unit (PDU), and more particularly, to a method and apparatus for counting transmission times of a PDU when the PDU is segmented into various sizes for retransmission, so as to determine whether a specific operation is performed.

2. Description of the Prior Art

The third generation mobile telecommunications system (called 3G system) provides high frequency spectrum utilization, universal coverage, and high quality, high-speed multimedia data transmission, and also meets all kinds of QoS requirements simultaneously, providing diverse, flexible, two-way transmission services and better communication quality to reduce transmission interruption rates. However, due to demand for high-speed and multimedia applications, the next generation mobile telecommunications technology and related communication protocols have been developed.

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B and RNC (Radio Network Controller) respectively, so that the system structure becomes simple.

A primary function of the RLC layer is providing data transfer service of different quality levels for upper layer, and can operate in different modes based on different transmission quality requirements, e.g. Transparent Mode (TM), Unacknowledged Mode (UM), and Acknowledged Mode (AM). TM is appropriate for use in services with high requirements for real-time transmission, UM is appropriate for use in services with requirements for real-time transmission and packet sequencing, and AM is appropriate for use in services with low requirements for real-time transmission, but high requirements for data accuracy.

In AM, the RLC layer, either in the E-UTRAN or in the UE, consists of a transmitting side and a receiving side. The transmitting side of the RLC layer receives RLC SDUs (Service Data Units) from upper layer and sends RLC PDUs (Protocol Data Units) to its peer receiving side via lower layers. The receiving side of the RLC layer receives RLC PDUs from its peer transmitting side via lower layers and delivers RLC SDUs to upper layer. Furthermore, the transmitting side of the RLC layer performs operation such as segmentation, concatenation and sequence check on RLC SDUs from upper layer according to a TB (Transportation Block) size indicated by the MAC layer at each transmission opportunity, so as to form AM data (AMD) PDUs or AMD PDU segments.

On the other hand, for better data accuracy and robustness, RLC layers of a transmitter and a receiver initiate a status report procedure at an appropriate time to have the transmitter poll the receiver, so that the receiver transmits a STATUS report to the transmitter. According to the STATUS report, the transmitter determines a reception status of PDUs received by the receiver, and decides to retransmit PDUs if necessary, so as to maintain data accuracy.

In the prior art, the LTE system can support segmenting or re-segmenting of an RLC PDU due to radio condition change, so that the transmitting side of the RLC layer further segments the RLC PDUs (or RLC PDU segments) those are needed for retransmission into RLC PDU segments with smaller sizes according to a TB size currently selected by the MAC layer.

However, the prior art does not specify how to count transmission times of a PDU when the PDU is segmented into various sizes for retransmission. In this case, the communications device cannot determine whether to perform operation such as discard, polling and etc., so as to lower system efficiency.

### SUMMARY OF THE INVENTION

According to the present invention, a method for counting transmission times of a Protocol Data Unit (PDU) in a wireless communications system is disclosed, so as to trigger a specific operation of a Radio Link Control (RLC) entity corresponding to the PDU. The method includes steps of performing a first transmission of the PDU and configuring a counter corresponding to transmission times of the PDU; and counting one time to the counter if a transmission after the first transmission of the PDU includes any part of the PDU.

According to the present invention,a communications device for counting transmission times of a Protocol Data Unit (PDU) in a wireless communications system is disclosed, so as to trigger a specific operation of a Radio Link Control (RLC) entity corresponding to the PDU. The communications device includes a processor, for executing a program, and a memory coupled to the processor for storing the program. The program includes steps of performing a first transmission of the PDU and configuring a counter corresponding to transmission times of the PDU; and counting one time to the counter if a transmission after the first transmission of the PDU includes any part of the PDU.

According to the present invention, a method for counting transmission times of a Protocol Data Unit (PDU) in a wireless communications system is disclosed, so as to trigger a specific operation of a Radio Link Control (RLC) entity corresponding to the PDU. The method includes steps of performing a first transmission of the PDU and configuring a counter corresponding to transmission times of the PDU; and counting one time to the counter if a transmission after the first transmission of the PDU includes a part of the PDU and a number of times the part being transmitted is greater than a value of the counter.

According to the present invention,a communications device for counting transmission times of a Protocol Data Unit (PDU) in a wireless communications system is disclosed, so as to trigger a specific operation of a Radio Link Control (RLC) entity corresponding to the PDU. The communications device includes a processor, for executing a program, and a memory coupled to the processor for storing the program. The program includes steps of performing a first transmission of the PDU and configuring a counter corresponding to transmission times of the PDU; and counting one time to the counter if a transmission after the first transmission of the PDU includes a part of the PDU and a number of times the part being transmitted is greater than a value of the counter.

According to the present invention, a method for counting transmission times of a Protocol Data Unit (PDU) in a wireless communications system is disclosed, so as to trigger a specific operation of a Radio Link Control (RLC) entity corresponding to the PDU. The method includes steps of performing a first transmission of the PDU and configuring a counter corresponding to transmission times of the PDU; and counting one time to the counter no matter whether any part of the PDU is retransmitted at a transmission opportunity after the first transmission of the PDU is performed, wherein the transmission opportunity is a transmission opportunity of the PDU, the RLC entity or a user equipment (UE) of the RLC entity.

According to the present invention,a communications device for counting transmission times of a Protocol Data Unit (PDU) in a wireless communications system is disclosed, so as to trigger a specific operation of a Radio Link Control (RLC) entity corresponding to the PDU. The communications device includes a processor, for executing a program, and a memory coupled to the processor for storing the program. The program includes steps of performing a first transmission of the PDU and configuring a counter corresponding to transmission times of the PDU; and counting one time to the counter no matter whether any part of the PDU is retransmitted at a transmission opportunity after the first transmission of the PDU is performed, wherein the transmission opportunity is a transmission opportunity of the PDU, the RLC entity or a user equipment (UE) of the RLC entity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a wireless communications system.

FIG. 2 is a functional block diagram of a communications device.

FIG. 3 is a diagram of the program shown in FIG. 2.

FIG. 4 is a schematic diagram of a process according to an embodiment of the present invention.

FIG. 5 is a schematic diagram of an embodiment applying the process of FIG. 4.

FIG. 6 is a schematic diagram of a process according to an embodiment of the present invention.

FIG. 7 is a schematic diagram of an embodiment applying the process of FIG. 6.

FIG. 8 is a schematic diagram of a process according to an embodiment of the present invention.

FIG. 9 is a schematic diagram of an embodiment applying the process of FIG. 8.

### DETAILED DESCRIPTION

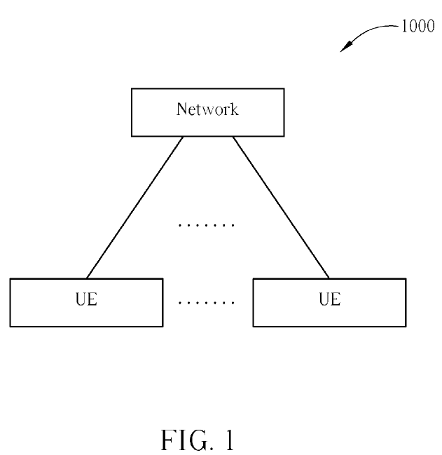

Please refer to FIG. 1, which illustrates a schematic diagram of a wireless communications system 1000. The wireless communications system 1000 can be a 3G mobile telecommunications system, an LTE (long-term evolution) system or other mobile communications systems, and is briefly composed of a network and a plurality of UEs. In FIG. 1, the network and the UEs are simply utilized for illustrating the structure of the wireless communications system 1000. Practically, the network may comprise a plurality of base stations (Node Bs), radio network controllers and so on according to actual demands, and the UEs can be devices such as mobile phones, computer systems, etc. Besides, the network and the UE can be seen as a transmitter or receiver according to transmission direction, e.g., for uplink, the UE is the transmitter and the network is the receiver, and for downlink, the network is the transmitter and the UE is the receiver.

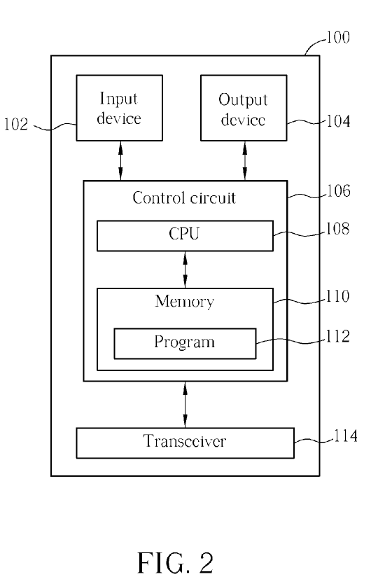

Please refer to FIG. 2, which is a functional block diagram of a communications device 100. The communications device 100 is utilized for realizing the network or the UEs. For the sake of brevity, FIG. 2 only shows an input device 102, an output device 104, a control circuit 106, a central processing unit (CPU) 108, a memory 110, a program 112, and a transceiver 114 of the communications device 100. In the communications device 100, the control circuit 106 executes the program 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

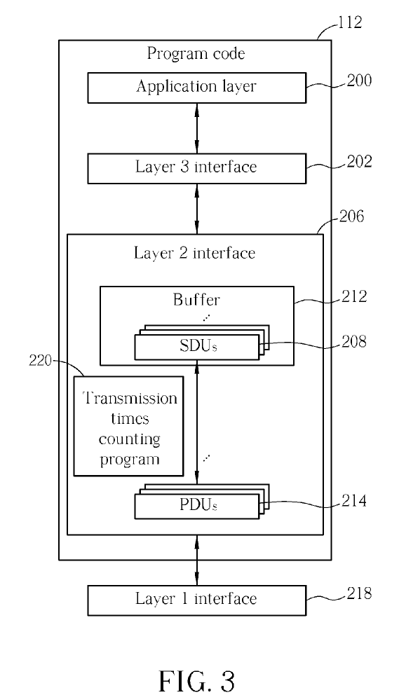

Please continue to refer to FIG. 3. FIG. 3 is a diagram of the program 112 shown in FIG. 2. The program 112 includes an application layer 200, a Layer 3 202, and a Layer 2 206, and is coupled to a Layer 1 218. The Layer 3 202 comprises a Packet Data Convergence Protocol (PDCP) layer 208. The Layer 2 206 comprises an RLC layer and a MAC layer, and performs link control. The Layer 1 218 performs physical connections. Note that, although the PDCP layer 208 is contained in the block of Layer 3 202 in FIG. 2, it could also be seen as contained in the block of Layer 2 206. Whether the PDCP layer 208 is considered to belong to Layer 2 or Layer 3 is not relevant to this invention.

In the LTE system, the Layer 2 206 can support segmenting or re-segmenting of an RLC PDU due to radio condition change, so that the RLC PDUs (or RLC PDU segments) can be segmented into RLC PDU segments with smaller sizes for retransmission. In this case, the embodiment of the present invention provides a transmission times counting program 220 for counting transmission times of a Protocol Data Unit (PDU) in a wireless communications system, so as to trigger a specific operation of a Radio Link Control (RLC) entity, such as discarding the PDU or executing polling functionality of the PDU, thereby enhancing system efficiency.

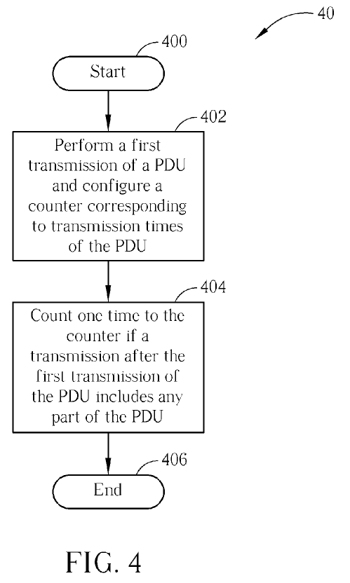

Please refer to FIG. 4. FIG. 4 is a schematic diagram of a process 40 according to an embodiment of the present invention. The process 40 is utilized for implementing the transmission times counting program 220, and includes the following steps:

Step 400: Start.

Step 402: Perform a first transmission of a PDU and configure a counter corresponding to transmission times of the PDU.

Step 404: Count one time to the counter if a transmission after the first transmission of the PDU includes any part of the PDU.

Step 406: End.

According to the process 40, the embodiment of the present invention configures a counter corresponding to transmission times of the PDU when a first transmission of the PDU is performed. Afterwards, if a transmission includes any part of the PDU, one time is counted to the counter. Therefore, when the counter reaches to a predetermined value, a specific operation corresponding to the PDU, such as discarding the PDU or executing polling functionality of the PDU, can be triggered correctly, so as to enhance system efficiency.

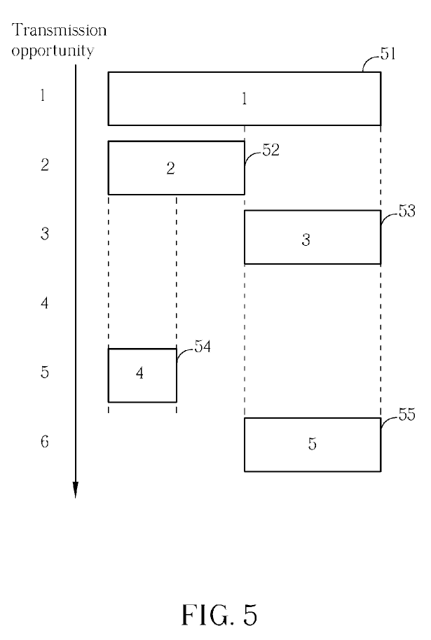

For example, please refer to FIG. 5. FIG. 5 is a schematic diagram of an embodiment applying the process 40 of the present invention. As shown in FIG. 5, if a RLC PDU 51 is performed its first transmission at a first transmission opportunity, a counter corresponding to transmission times of the PDU can be configured according to the process 40, and its initial value is set as “1”. Next, since some parts of the RLC PDU 51, i.e. RLC PDU segments 52 and 53 are retransmitted at both a second and a third transmission opportunity, the counter is then added one time, respectively. By comparison, since no data of the RLC PDU 51 is retransmitted at a fourth transmission opportunity, the value of the counter is kept unchanged. Thus, in like manners, the counted transmission times of the original RLC PDU 51 after a sixth transmission opportunity is “5”.

Please note that, the transmission opportunity of the present invention can be considered as a transmission opportunity of the RLC PDU, a transmission opportunity of the RLC entity, or a transmission opportunity of a user equipment (UE) which the RLC entity belongs to, and is not limited. For example, if considered as the transmission opportunity of the UE, each of the above transmission opportunity can be a particular Transmission Time Interval (TTI) when the MAC layer is allocated a transport block (TB) for transmission by the network; or if considered as the transmission opportunity of the RLC entity, each of the above transmission opportunity can be a time point when a corresponding logic channel is allocated a channel resource for transmission by the network.

Consequently, in the embodiment of the present invention, when any part of the PDU is retransmitted at a transmission opportunity, one time is counted into the transmission times of the PDU.

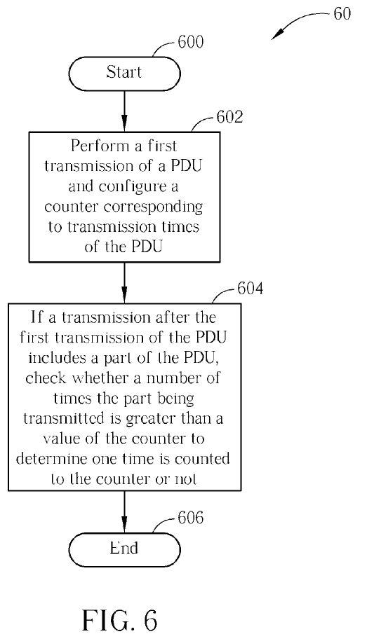

Please further refer to FIG. 6. FIG. 6 is a schematic diagram of a process 60 according to an embodiment of the present invention. The process 60 is also utilized for implementing the transmission times counting program 220, and includes the following steps:

Step 600: Start.

Step 602: Perform a first transmission of a PDU and configure a counter corresponding to transmission times of the PDU.

Step 604: If a transmission after the first transmission of the PDU includes a part of the PDU, check whether a number of times the part being transmitted is greater than a value of the counter to determine one time is counted to the counter or not.

Step 606: End.

According to the process 60, a counter corresponding to transmission times of the PDU is configured when a first transmission of the PDU is performed. Afterwards, if a transmission includes a part of the PDU, e.g. a segment of the PDU, the number of times the part being transmitted is firstly checked to determine whether one time is counted to the counter. When the transmission times of the part is greater than the value of the counter, one time is counted; Conversely, the counter is kept unchanged when the number of times the part being transmitted is smaller than or equal to the value of the counter.

Therefore, when the counter reaches to a predetermined value, a specific operation corresponding to the PDU, such as discarding the PDU or executing polling functionality of the PDU, can be triggered for enhancing system efficiency.

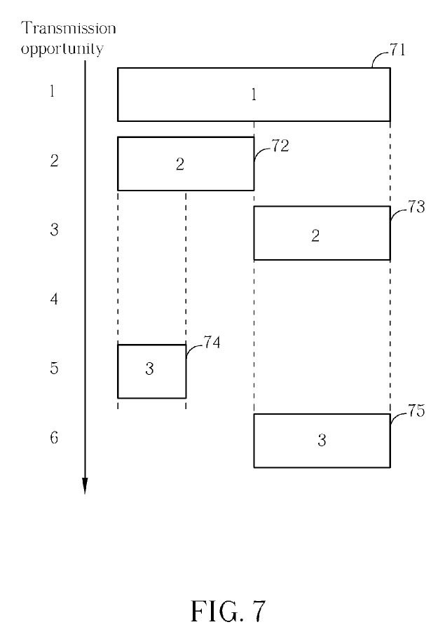

For example, please refer to FIG. 7. FIG. 7 is a schematic diagram of an embodiment applying the process 60 of the present invention. As shown in FIG. 7, if a RLC PDU 71 is performed its first transmission at a first transmission opportunity, a counter corresponding to transmission times of the PDU can be configured according to the process 60, and its initial value is set as “1”. Then, a segment of the RLC PDU 71, i.e. a RLC PDU segment 72, is transmitted at a second transmission opportunity, and since the number of times the part being transmitted is greater than the value of the counter, one time is counted. However, for a RLC PDU segment 73 transmitted at a third transmission opportunity, since the number of times the part being transmitted is not greater than the value of the counter, the value of the counter is kept unchanged. Therefore, in a same transmission scenario as FIG. 5, the counted transmission times of the original RLC PDU 71 is “3”.

In other words, if a part of the PDU is retransmitted at a transmission opportunity and the number of times the part being transmitted is greater than a current value of the counter, one time is counted to the counter; conversely, the counter is kept unchanged.

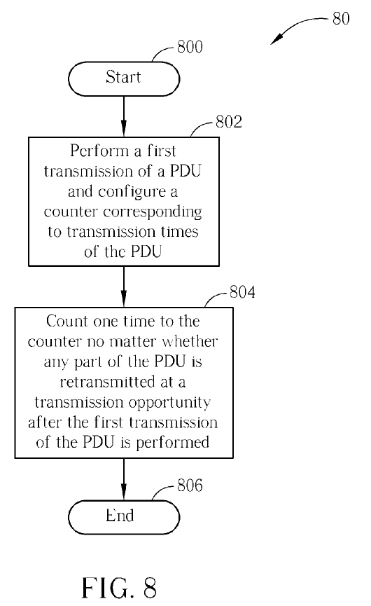

Please further refer to FIG. 8. FIG. 8 is a schematic diagram of a process 80 according to an embodiment of the present invention. The process 80 is also utilized for implementing the transmission times counting program 220, and includes the following steps:

Step 800: Start.

Step 802: Perform a first transmission of a PDU and configure a counter corresponding to transmission times of the PDU.

Step 804: Count one time to the counter no matter whether any part of the PDU is retransmitted at a transmission opportunity after the first transmission of the PDU is performed.

Step 806: End.

According to the process 80, a counter corresponding to transmission times of the PDU is configured when a first transmission of the PDU is performed. Afterwards, no matter whether any part of the PDU is retransmitted at a transmission opportunity, one time is counted to the counter.

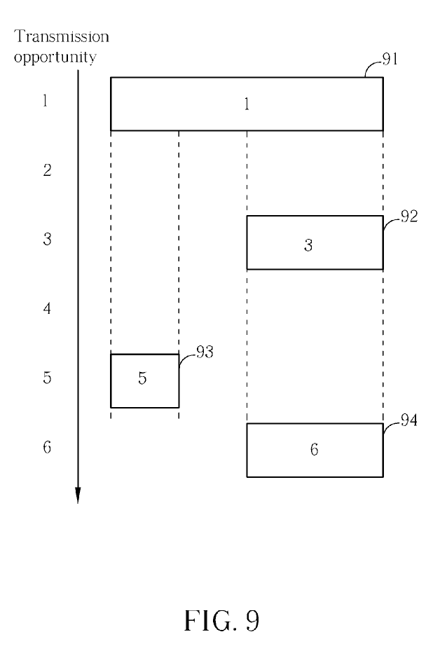

For example, please refer to FIG. 9. FIG. 9 is a schematic diagram of an embodiment applying the process 80 of the present invention. As shown in FIG. 9, if a RLC PDU 91 is performed its first transmission at a first transmission opportunity, a counter corresponding to transmission times of the PDU can be configured according to the process 80, and its initial value is set as “1”. Next, no matter whether any part of the RLC PDU 91 is retransmitted at a transmission opportunity, one time is counted to the counter. Therefore, in the embodiment of the present invention, the counted transmission times of the original RLC PDU 91 after a sixth transmission opportunity is “6”.

That means, in the embodiment of the present invention, the transmission times of the PDU is equal to a number of transmission opportunities that the PDU being allocated.

As mentioned above, the present invention provides the method for counting the transmission times of the PDU when the PDU is segmented into various sizes for retransmission, so that a specific operation corresponding to the PDU, such as discarding the PDU or executing polling functionality of the PDU, can be triggered when retransmission of the PDU is requested unceasingly, thereby enhancing system efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for counting transmission times of a Protocol Data Unit (PDU) in a wireless communications system, so as to trigger a specific operation of a Radio Link Control (RLC) entity corresponding to the PDU, the method comprising:
performing a first transmission of the PDU and configuring a counter corresponding to transmission times of the PDU; and
counting one time to the counter if a transmission after the first transmission of the PDU includes any part of the PDU.

2. The method of claim 1, wherein configuring the counter corresponding to the transmission times of the PDU comprises initiating the counter.

3. The method of claim 1, wherein the specific operation comprises executing discard functionality of the RLC entity.

4. The method of claim 1, wherein the specific operation comprises executing polling functionality of the RLC entity.

5. The method of claim 1, wherein the PDU is a Radio Link Control (RLC) PDU, and retransmission of the RLC PDU can be some part of the RLC PDU.

6. A communications device for counting transmission times of a Protocol Data Unit (PDU) in a wireless communications system, so as to trigger a specific operation of a Radio Link Control (RLC) entity corresponding to the PDU, the communications device comprising:
a processor, for executing a program; and
a memory coupled to the processor for storing the program;
wherein the program comprises:
performing a first transmission of the PDU and configuring a counter corresponding to transmission times of the PDU; and
counting one time to the counter if a transmission after the first transmission of the PDU includes any part of the PDU.

7. The communications device of claim 6, wherein configuring the counter corresponding to the transmission times of the PDU comprises initiating the counter.

8. The communications device of claim 6, wherein the specific operation comprises executing discard functionality of the RLC entity.

9. The communications device of claim 6, wherein the specific operation comprises executing polling functionality of the RLC entity.

10. The communications device of claim 6, wherein the PDU is a Radio Link Control (RLC) PDU, and retransmission of the RLC PDU can be some part of the RLC PDU.

11. A method for counting transmission times of a Protocol Data Unit (PDU) in a wireless communications system, so as to trigger a specific operation of a Radio Link Control (RLC) entity corresponding to the PDU, the method comprising:
performing a first transmission of the PDU and configuring a counter corresponding to transmission times of the PDU; and
counting one time to the counter if a transmission after the first transmission of the PDU includes a part of the PDU and a number of times the part being transmitted is greater than a value of the counter.

12. The method of claim 11, wherein configuring the counter corresponding to the transmission times of the PDU comprises initiating the counter.

13. The method of claim 11 further comprising:
keeping the value of the counter unchanged when the number of times the part being transmitted is smaller than or equal to the value of the counter.

14. The method of claim 11, wherein the specific operation comprises executing discard functionality of the RLC entity.

15. The method of claim 11, wherein the specific operation comprises executing polling functionality of the RLC entity.

16. The method of claim 11, wherein the PDU is a Radio Link Control (RLC) PDU, and retransmission of the RLC PDU can be some part of the RLC PDU.

17. A communications device for counting transmission times of a Protocol Data Unit (PDU) in a wireless communications system, so as to trigger a specific operation of a Radio Link Control (RLC) entity corresponding to the PDU, the communications device comprising:
a processor, for executing a program; and
a memory coupled to the processor for storing the program;
wherein the program comprises:
performing a first transmission of the PDU and configuring a counter corresponding to transmission times of the PDU; and
counting one time to the counter if a transmission after the first transmission of the PDU includes a part of the PDU and a number of times the part being transmitted is greater than a value of the counter.

18. The communications device of claim 17, wherein configuring the counter corresponding to the transmission times of the PDU comprises initiating the counter.

19. The communications device of claim 17, wherein the program further comprises:
keeping the value of the counter unchanged when the number of times the part being transmitted is smaller than or equal to the value of the counter.

20. The communications device of claim 17, wherein the specific operation comprises executing discard functionality of the RLC entity.

21. The communications device of claim 17, wherein the specific operation comprises executing polling functionality of the RLC entity.

22. The communications device of claim 11, wherein the PDU is a Radio Link Control (RLC) PDU, and retransmission of the RLC PDU can be some part of the RLC PDU.

23. A method for counting transmission times of a Protocol Data Unit (PDU) in a wireless communications system, so as to trigger a specific operation of a Radio Link Control (RLC) entity corresponding to the PDU, the method comprising:
performing a first transmission of the PDU and configuring a counter corresponding to transmission times of the PDU; and
counting one time to the counter no matter whether any part of the PDU is retransmitted at a transmission opportunity after the first transmission of the PDU is performed, wherein the transmission opportunity is a transmission opportunity of the PDU, the RLC entity or a user equipment (UE) of the RLC entity.

24. The method of claim 23, wherein configuring the counter corresponding to the transmission times of the PDU comprises initiating the counter.

25. The method of claim 23, wherein the specific operation comprises executing discard functionality of the RLC entity.

26. The method of claim 23, wherein the specific operation comprises executing polling functionality of the RLC entity.

27. The method of claim 23, wherein the PDU is a Radio Link Control (RLC) PDU, and retransmission of the RLC PDU can be some part of the RLC PDU.

28. A communications device for counting transmission times of a Protocol Data Unit (PDU) in a wireless communications system, so as to trigger a specific operation of a Radio Link Control (RLC) entity corresponding to the PDU, the communications device comprising:
a processor, for executing a program; and
a memory coupled to the processor for storing the program;
wherein the program comprises:
performing a first transmission of the PDU and configuring a counter corresponding to transmission times of the PDU; and
counting one time to the counter no matter whether any part of the PDU is retransmitted at a transmission opportunity after the first transmission of the PDU is performed, wherein the transmission opportunity is a transmission opportunity of the PDU, the RLC entity or a user equipment (UE) of the RLC entity.

29. The communications device of claim 28, wherein configuring the counter corresponding to the transmission times of the PDU comprises initiating the counter.

30. The communications device of claim 28, wherein the specific operation comprises executing discard functionality of the RLC entity.

31. The communications device of claim 28, wherein the specific operation comprises executing polling functionality of the RLC entity.

32. The communications device of claim 28, wherein the PDU is a Radio Link Control (RLC) PDU, and retransmission of the RLC PDU can be some part of the RLC PDU.
